(19) United States
(12) Patent Application Publication
(10) Pub. No.: US 2026/0241743 A1
(43) Pub. Date: Aug. 20, 2026

(54) CASTER WHEEL SUSPENSION APPARATUS OF REACH TYPE FORKLIFT

(71) Applicant: DOOSAN BOBCAT KOREA CO., LTD., Incheon (KR)

(72) Inventor: Kyuhyun SHIM, Incheon (KR)

(73) Assignee: DOOSAN BOBCAT KOREA CO., LTD., Incheon (KR)

(21) Appl. No.: 19/234,045

(22) Filed: Jun. 10, 2025

(30) Foreign Application Priority Data
Feb. 17, 2025 (KR) 10-2025-0020108

(51) Int. Cl. B60B 33/04; B60G 17/02; B66F 9/075

(52) U.S. Cl. CPC B60B 33/045; B60G 17/021; B66F 9/07586; B60B 2900/561; B60G 2204/41; B60G 2204/44; B60G 2204/45; B60G 2300/022; B60G 2500/30

(57) ABSTRACT

Disclosed is a caster wheel suspension apparatus of a reach type forklift. The caster wheel suspension apparatus of the reach type forklift according to an embodiment may include a fixed plate including guide rods respectively fixed to front and rear sides of a low surface of the fixed plate, the fixed plate fixed to a body, a movable plate including a movable pipe surrounding each of the guide rods and configured to be movable upward and downward along the guide rod, a suspension spring surrounding the movable pipe and positioned between the lower surface of the fixed plate and an upper surface of the movable plate, and a caster assembly configured to enable the caster wheel to freely rotate according to a driving action and a steering action of the driving wheel, the caster assembly coupled to a lower surface of the movable plate.

### CROSS-REFERENCE TO RELATED APPLICATION(S)

This application is based on and claims priority under 35 U.S.C. § 119 to Korean Patent Application No. 10-2025-0020108, filed on Feb. 17, 2025, in the Korean Intellectual Property Office, the disclosure of which is incorporated by reference herein in its entirety.

### BACKGROUND

### 1. Field

The disclosure relates to a caster wheel suspension apparatus of a reach type forklift, and more particularly, to a caster wheel suspension apparatus of a reach type forklift, capable of improving maintainability and driving stability by simplifying a suspension structure of a caster wheel.

### 2. Description of the Related Art

Forklifts are industrial vehicles used to lift and transport heavy loads. The forklifts are widely used for unloading work in various industrial sites.

The forklifts are broadly classified into counterbalance type forklifts and reach type forklifts depending on their structure and function.

The counterbalance type forklifts are equipped with a weight at the rear of the body to support the load on the forks in a balanced manner, thereby transporting heavy loads stably. The counterbalance type forklifts are a sitting type that is operated by the driver in a sitting position, which is advantageous for long-term work.

The reach type forklifts maintain stability through outriggers protruding from the front of the body, and the forks move forward and backward to perform unloading work. The reach type forklifts are mainly used in logistics warehouses and large marts because they can work efficiently in narrow spaces compared to the counterbalance type forklifts and are advantageous in handling loads located at high positions. The reach type forklifts are a standing type that is operated by the driver in a standing position, which makes it easy for the driver to get on and off the forklifts.

FIG. 1 is a side view showing a schematic configuration of a conventional reach type forklift, and FIG. 2 is a cross-sectional view showing a cross section taken along line A-A′ of FIG. 1. Referring to FIGS. 1 and 2, the conventional reach type forklift includes a pair of outriggers 2 extending forward in parallel from a lower portion of a body 1. Between the pair of outriggers 2, a pair of forks 6 are positioned to lift a load. A front end of each outrigger 2 is equipped with a front wheel 3 having a small diameter, and a rear portion of the body 1 is equipped with rear wheels 5 each having a relatively large diameter. The rear wheels 5 are configured with driving wheels 5a that drive and steer the body 1 and caster wheels 5b that idle at the other sides of the driving wheels 5a. The driving wheels 5a are configured to be driven by a driving motor and steered by a driver's control. Also, the driving wheels 5a and the caster wheels 5b are connected to each other by an axle beam 7 installed rotatably about a support shaft 8 on a support frame 4 of the body 1.

However, since the conventional reach type forklift has a structure in which the axle beam 7 is connected to the driving wheels 5a and the caster wheels 5b below a driver's boarding space, there are disadvantages that it takes a lot of time to assemble the axle beam 7, maintenance is not easy, and the floor of the driver's boarding space is in a high position.

In addition, the conventional reach type forklift has a problem in that two caster wheels 5b rotate about the support shaft 8 to perform suspension, which easily causes eccentric wear of the tires of the caster wheels 5b.

### SUMMARY

It is an embodiment of the disclosure to provide a caster wheel suspension apparatus of a reach type forklift, capable of changing a suspension structure of a caster wheel from a rotational motion to an up-and-down vertical motion.

It is an embodiment of the disclosure to provide a caster wheel suspension apparatus of a reach type forklift, which has a compact structure to minimize a floor height of a driver boarding space from the ground and secure a relatively large driver boarding space.

It is an embodiment of the disclosure to provide a caster wheel suspension apparatus of a reach type forklift, capable of reducing the number of caster wheels from two to one to thereby reduce a size and weight of a structure for installing the caster wheel.

Additional aspects of the disclosure will be set forth in part in the description which follows and, in part, will be obvious from the description, or may be learned by practice of the disclosure.

In accordance with an embodiment of the disclosure, there is provided a caster wheel suspension apparatus of a reach type forklift including a driving wheel provided at one side of a lower portion of a body and a caster wheel provided at another side of the lower portion of the body, the caster wheel suspension apparatus including a fixed plate including guide rods respectively fixed to front and rear sides of a lower surface of the fixed plate, the fixed plate fixed to the body, a movable plate including a movable pipe surrounding each of the guide rods and configured to move upward and downward along the guide rod, a suspension spring surrounding the movable pipe and positioned between the lower surface of the fixed plate and an upper surface of the movable plate, and a caster assembly configured to enable the caster wheel to freely rotate according to a driving action and a steering action of the driving wheel, the caster assembly coupled to a lower surface of the movable plate.

Each of the guide rods may include a first stopper provided at an upper end of the guide rod and configured to limit an upward movement of the movable pipe, a second stopper provided at a lower end of the guide rod and configured to limit a downward movement of the movable pipe, and the guide rod may be fixed to the lower surface of the fixed plate by a first fastening bolt penetrating the fixed plate from an upper surface of the fixed plate.

The fixed plate may include a spacer provided between the lower surface of the fixed plate and an upper surface of the first stopper and configured to adjust a height of the guide rod from the fixed plate.

The suspension spring may be positioned between a lower surface of the first stopper and the upper surface of the movable plate.

The movable plate may further include a first nipple configured to supply lubricating oil from one side of the movable plate to a space between the movable pipe and the guide rod.

The movable pipe may include a movable plate supporting portion protruding from an outer surface of a lower end of the movable pipe and supporting the movable plate, and an inner protrusion protruding toward the guide rod from an inner surface of the movable pipe at a center in longitudinal direction of the movable pipe.

The movable pipe may further include a first bushing provided between a first fixing ring provided on an inner surface of an upper end of the movable pipe and the inner protrusion, and a second bushing provided between a second fixing ring provided on an inner surface of a lower end of the movable pipe and the inner protrusion.

The caster assembly may include a caster housing including a caster bracket shaft configured to rotate according to a steering action of the driving wheel, and fixed and coupled to the movable plate, and a caster bracket including a caster wheel shaft to which the caster wheel is coupled, the caster wheel shaft configured to rotate according to a driving action of the driving wheel, the caster bracket fixed and coupled to a lower end of the caster bracket shaft.

The caster assembly may further include a caster bracket shaft bearing provided between an inner side of the caster housing and an outer surface of the caster bracket shaft, and a caster wheel shaft bearing provided between the caster bracket and an outer surface of the caster wheel shaft.

The caster housing may include a second nipple configured to supply lubricating oil from an upper surface of the caster housing to the caster bracket shaft bearing.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a side view showing a schematic configuration of a conventional reach type forklift;

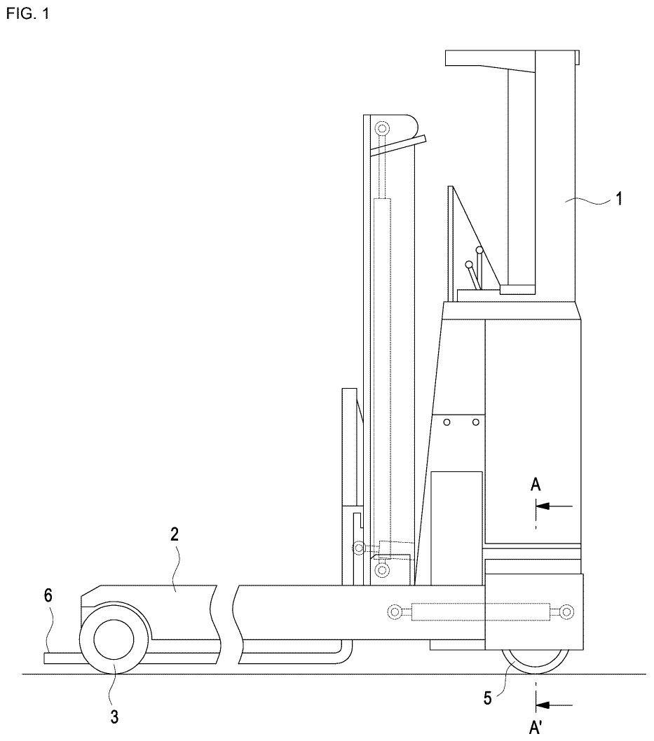

FIG. 2 is a cross-sectional view showing a cross section taken along line A-A′ of FIG. 1;

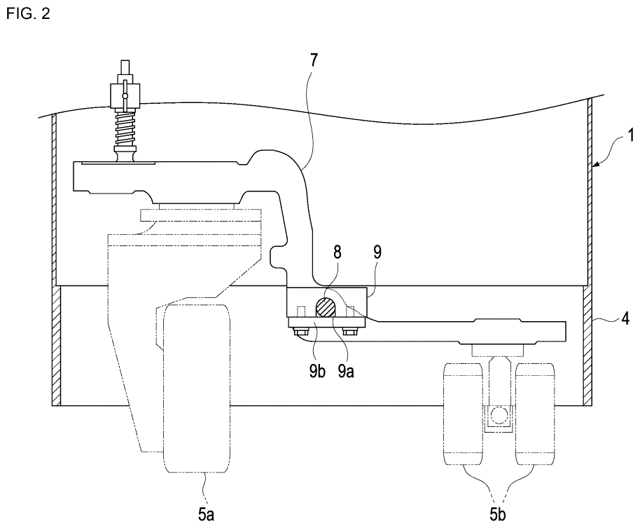

FIG. 3 is a perspective view showing an upper portion of a caster wheel suspension apparatus of a reach type forklift according to an embodiment of the disclosure;

FIG. 4 is a perspective view showing a lower portion of a caster wheel suspension apparatus of a reach type forklift according to an embodiment of the disclosure;

FIG. 5 is a cross-sectional view showing a state in which a caster wheel suspension apparatus of a reach type forklift according to an embodiment of the disclosure has been installed in the reach type forklift;

FIG. 6 is a cross-sectional view showing an initial state of a caster wheel suspension apparatus of a reach type forklift according to an embodiment of the disclosure; and

FIG. 7 is a cross-sectional view showing an operation state of a caster wheel suspension apparatus of a reach type forklift according to an embodiment of the disclosure.

### DETAILED DESCRIPTION

Hereinafter, embodiments of the disclosure will be described in detail with reference to the accompanying drawings. The following embodiments are provided to sufficiently transfer the concepts of the disclosure to one of ordinary skill in the technical art to which the disclosure belongs. However, the disclosure is not limited to these embodiments and may be embodied in another form. In the drawings, parts that are irrelevant to the descriptions may not be shown in order to clarify the disclosure, and also, for easy understanding, the sizes of components are more or less exaggeratedly shown.

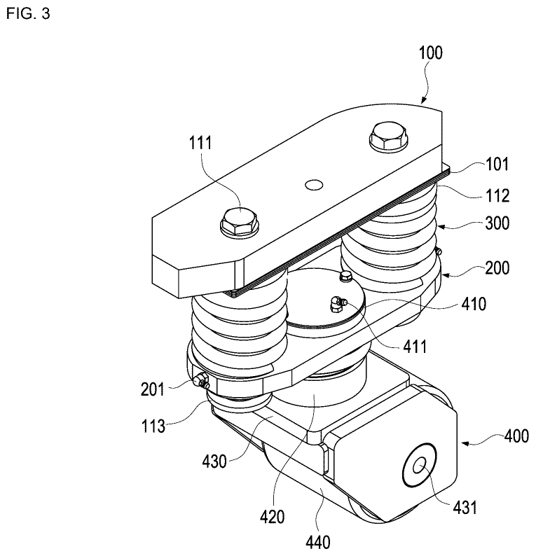

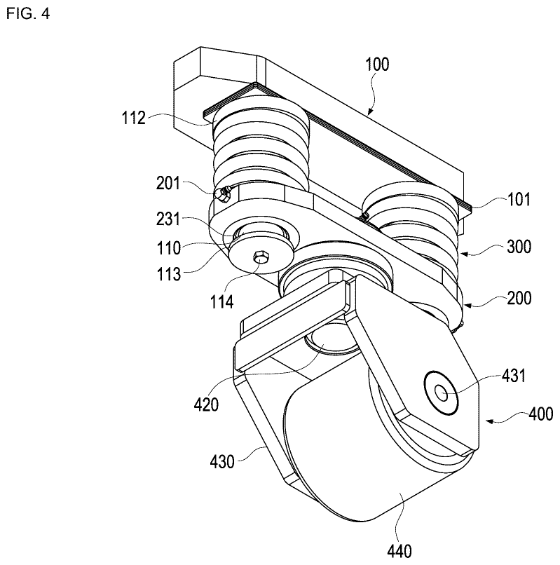

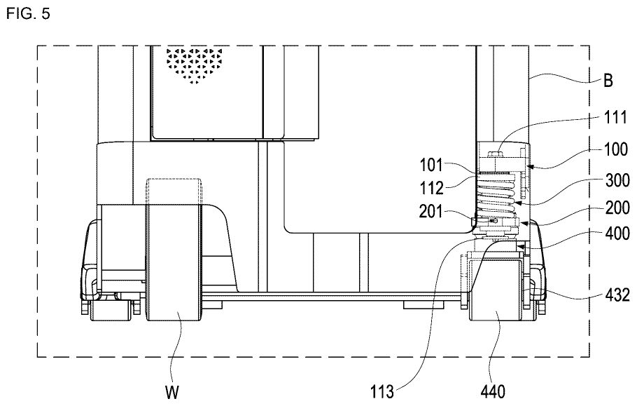

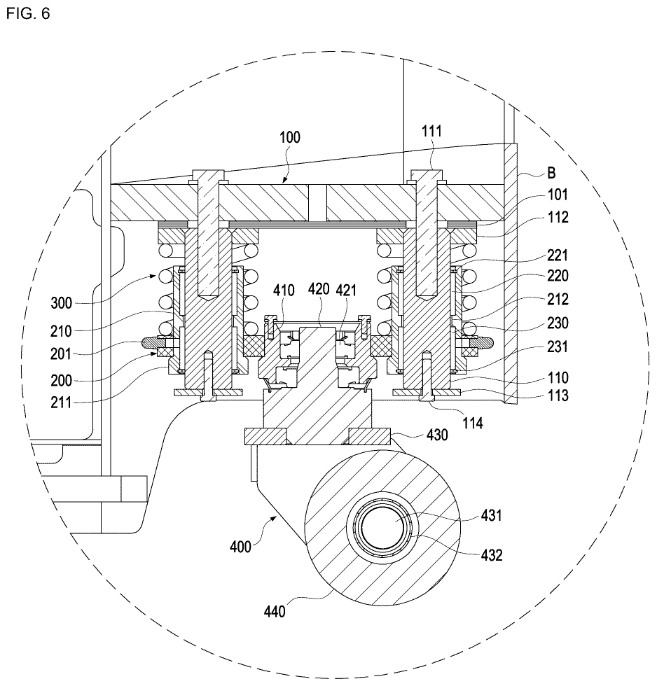

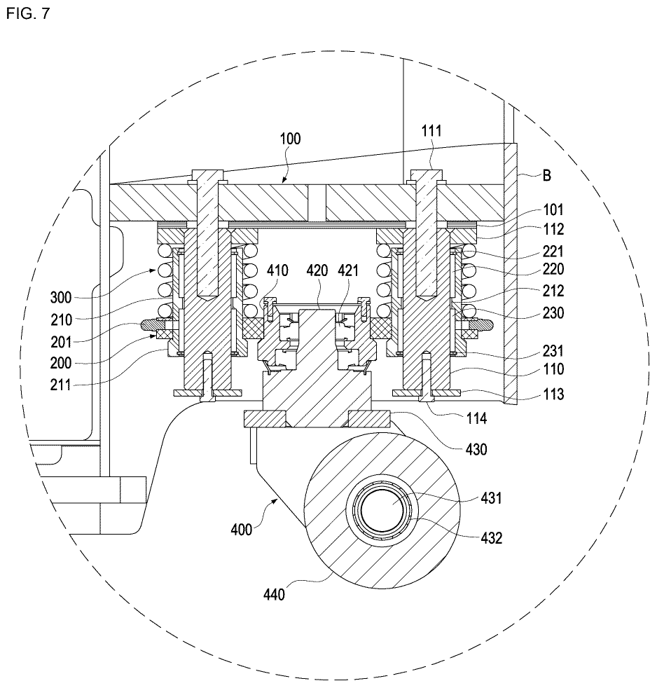

FIG. 3 is a perspective view showing an upper portion of a caster wheel suspension apparatus of a reach type forklift according to an embodiment of the disclosure, FIG. 4 is a perspective view showing a lower portion of a caster wheel suspension apparatus of a reach type forklift according to an embodiment of the disclosure, FIG. 5 is a cross-sectional view showing a state in which a caster wheel suspension apparatus of a reach type forklift according to an embodiment of the disclosure has been installed in the reach type forklift, and FIGS. 6 and 7 are cross-sectional views showing an initial state and an operation state of a caster wheel suspension apparatus of a reach type forklift according to an embodiment of the disclosure.

Referring to FIGS. 3 to 7, the caster wheel suspension apparatus of the reach type forklift according to an embodiment of the disclosure may be applied to a reach type forklift in which a driving wheel W is provided at one side of a lower portion of a body B and a caster wheel 400 is provided at another side of the lower portion of the body B, and the caster wheel suspension apparatus may include a fixed plate 100, an movable plate 200 positioned below the fixed plate 100 in such a way as to be movable upward and downward with respect to the fixed plate 100, a suspension spring 300 positioned between the fixed plate 100 and the movable plate 200 to provide an elastic force to the movable plate 200, and a caster assembly 400 coupled to the movable plate 200 to enable a caster wheel 440 to freely rotate according to a driving action and a steering action of the driving wheel W.

The fixed plate 100 may include guide rods 110 respectively fixed to front and rear sides of the lower surface, and the fixed plate 100 may be fixed to a lower portion of an inner side of a side wall of the body B that is adjacent to the caster wheel 440. The fixed plate 100 may be a polygonal plate extending in a longitudinal direction of the body B, rather than a width direction of the body B.

Each guide rod 110 may be a shaft having a circular cross section and may be fixed to the lower surface of the fixed plate 100 by a first fastening bolt 111 penetrating the fixed plate 100 from an upper surface of the fixed plate 100. Also, the guide rod 110 may include a first stopper 112 provided at the upper end and a second stopper 113 provided at the lower end.

The first stopper 112 may limit an upward movement of the movable plate 200 and may be formed as an annular plate whose inner side is coupled to an outer surface of an upper end of the guide rod 110. Also, the first stopper 112 may have an outer diameter larger than an outer diameter of the suspension spring 300 in order to stably support an upper end of the suspension spring 300.

The second stopper 113 may be formed as a circular plate to limit a downward movement of the movable plate 200 and may be fixed to a lower end of the guide rod 110 by a second fastening bolt 114 penetrating the second stopper 113 from a lower surface of the second stopper 113. Also, the second stopper 113 may have an outer diameter larger than an outer diameter of the guide rod 110 in order to prevent the movable plate 200 from departing from the lower end of the guide rod 110.

The movable plate 200 may include a movable pipe 210 surrounding the guide rod 110 provided at the front and rear sides of the lower surface of the fixed plate 100, as described above, and move upward and downward with respect to the fixed plate 100 along the guide rod 110 together with the movable pipe 210.

The movable pipe 210 may be a circular pipe having an annular cross section. While the movable plate 200 moves upward or downward with respect to the fixed plate 100, an upper end of the movable pipe 210 may come into contact with the first stopper 112 to limit the upward movement of the movable plate 200, and a lower end of the movable pipe 210 may come into contact with the second stopper 113 to limit the downward movement of the movable plate 200. Therefore, a length of the movable pipe 210 may depend on an upward and downward movement range of the movable plate 200 with respect to the fixed plate 100.

Also, the movable pipe 210 may include a movable plate supporting portion 211 protruding from an outer surface of the lower end of the movable pipe 210 and supporting a lower surface of the movable plate 200, and an inner protrusion 212 protruding toward the guide rod 110 from an inner surface of the movable pipe 210 at a center in longitudinal direction of the movable pipe 210 and spaced a preset gap from the guide rod 110 without contacting the outer surface of the guide rod 110.

Also, as shown in FIGS. 6 and 7, the movable pipe 210 may include a first bushing 220 and a second bushing 230 respectively provided on upper and lower sides of the inner surface, with the inner protrusion 212 in between, for a smooth upward/downward movement of the movable plate 200 along the guide rod 110. Here, the first bushing 220 may be fixed between the inner protrusion 212 and a first fixing ring 221 provided on an inner surface of the upper end of the movable pipe 210, and the second busing 230 may be fixed between the inner protrusion 212 and a second fixing ring 231 provided on an inner surface of the lower end of the movable pipe 210.

Also, the movable plate 200 may further include a first nipple 201 for supplying lubricating oil, such as grease, from one side of the movable plate 200 to a space between the movable pipe 210 and the guide rod 110 through a path formed in each of inside of the movable plate 200 and the movable pipe 210. Accordingly, the movable pipe 210 may more smoothy move upward and downward along the guide rod 110 by lubricating oil supplied through the first nipple 201.

The suspension spring 300 may be a coil compression spring surrounding an outer surface of the movable pipe 210, wherein an upper end of the suspension spring 300 is supported on a lower surface of the first stopper 112 and a lower end of the suspension spring 300 is supported on an upper surface of the movable plate 200 so as to provide an elastic force from the fixed plate 100 to the movable plate 200. To this end, an inner diameter of the suspension spring 300 may be larger than an outer diameter of the movable pipe 210, and an outer diameter of the suspension spring 300 may be smaller than an outer diameter of the first stopper 112.

The caster assembly 400 may include a caster housing 410 fixed and coupled to the movable plate 200, a caster bracket shaft 420 protruding toward a lower side of the caster housing 410 inside the caster housing 410 and being rotatable relative to the caster housing 410, and a caster bracket 430 coupled to a lower end of the caster bracket shaft 420, wherein both ends of a caster wheel shaft 431 which is a rotating shaft of the caster wheel 440 are coupled to the caster bracket 430 such that the caster wheel 440 is rotatable.

The cater housing 410 may be fixed and coupled to a center area of the movable plate 200 between the movable pipes 210 respectively provided in front and rear sides of the movable plate 200. Here, the caster housing 410 may be inserted into the movable plate 200 from the lower surface of the movable plate 200 such that an upper part of the caster housing 410 protrudes from the upper surface of the movable plate 200.

Also, the caster bracket shaft 420 may freely rotate with respect to the caster housing 410 according to a steering action of the driving wheel W. Also, the caster assembly 400 may further include a caster bracket shaft bearing 421 provided between an inner side of the caster housing 410 and the outer surface of the caster bracket shaft 420 to smoothly rotate the caster bracket shaft 420. Also, the caster housing 410 may include a second nipple 411 for supplying lubricating oil from the upper surface of the caster housing 410 to the caster bracket shaft bearing 421.

The caster bracket 430 may surround an upper portion and both sides of the caster wheel 440, and be fixed and coupled to the lower end of the caster bracket shaft 420 to freely rotate with respect to the caster housing 410 together with the caster bracket shaft 420 according to a steering action of the driving wheel W.

Also, the caster bracket 430 may support both ends of the caster wheel shaft 432 such that the caster wheel shaft 431 which is a rotating shaft of the caster wheel 440 freely rotates according to a driving action of the driving wheel W. Here, when the body B is viewed from the front or rear, a rotation axis of the caster wheel shaft 431 may be orthogonal to a rotation axis of the caster bracket shaft 420, and when the body B is viewed from the side, the rotation axis of the caster wheel shaft 431 may be located in front of or behind the rotation axis of the caster bracket shaft 420.

Also, the caster assembly 400 may further include a caster wheel shaft bearing 432 provided between the caster bracket 430 and an outer surface of the caster wheel shaft 431 to smoothly rotate the caster wheel shaft 431.

Accordingly, the caster wheel 440 may freely rotate together with the caster bracket shaft 420 according to a steering action of the driving wheel W, and freely rotate together with the caster wheel shaft 431 according to a driving action of the driving wheel W.

Meanwhile, an operation method of the caster wheel suspension apparatus of the reach type forklift according to an embodiment of the disclosure will be described with reference to FIGS. 6 and 7, below. An initial state of the caster wheel suspension apparatus of the reach type forklift according to an embodiment of the disclosure may be a state in which weight of the body B or weight of the body B and a driver is applied to the case wheel 440 supported on the ground, and in this state, the suspension spring 300 may be partially compressed. Also, an operation state of the caster wheel suspension apparatus of the reach type forklift according to an embodiment of the disclosure may be a state in which a load is loaded on forks (not shown) of the forklift and weight of the load, together with weight of the main body B and the driver, is applied to the caster wheel 440 supported on the ground, and in this state, the suspension spring 300 may be further compressed compared to the initial state.

Referring to FIG. 6, in the initial state of the caster wheel suspension apparatus of the reach type forklift according to an embodiment of the disclosure, the suspension spring 300 may be partially compressed, the lower end of the movable pipe 210 may be spaced a preset distance from a upper surface of the second stopper 113, and the movable plate 200 may be maintained in a state of being slightly raised from the lower end of the guide rod 110, together with the caster assembly 400.

Referring to FIG. 7, in the operation state of the caster wheel suspension apparatus of the reach type forklift according to an embodiment of the disclosure, the suspension spring 200 may be further compressed, the upper end of the movable pipe 210 may be adjacent to the lower surface of the first stopper 112, and the movable plate 200 may be maintained in a state of being raised up to the upper end of the guide rod 110, together with the caster assembly 400.

Accordingly, because a suspension action of the caster wheel 440 is performed by a up-and-down vertical motion made along the guide rod 110 to prevent eccentric wear of a tire of the caster wheel 440, the caster wheel suspension apparatus of the reach type forklift according to the present embodiment may further improve durability of the caster wheel 440. In addition, because the driving wheel W and the caster wheel 440 are not connected to each other and provided independently to minimize a floor height of the driver's boarding space and secure a relatively large driver's boarding space, the caster wheel suspension apparatus of the reach type forklift according to the present embodiment may improve a forklift driver's work efficiency. Also, because only one caster wheel 440 is provided to reduce a size and weight of a structure for installing the caster wheel 440, the caster wheel suspension apparatus of the reach type forklift according to the present embodiment may greatly improve assembling and maintaining properties of the forklift.

Because the caster wheel suspension apparatus of the reach type forklift according to the present embodiment changes a suspension structure of the caster wheel from a rotational motion to an up-and-down vertical motion, the caster wheel suspension apparatus may improve driving stability of the forklift and prevent eccentric wear of the caster tire caused by a rotation motion, thereby further improving durability of the caster wheel.

Because the caster wheel suspension apparatus of the reach type forklift according to the present embodiment has a compact structure, the caster wheel suspension apparatus may minimize the floor height of the driver boarding space from the ground and secure a relatively large driver boarding space, thereby improving a forklift driver's work efficiency.

Because the caster wheel suspension apparatus of the reach type forklift according to the present embodiment reduces the number of caster wheels from two to one, the caster wheel suspension apparatus may reduce a size and weight of a structure for installing the caster wheel, thereby greatly improve assembling and maintaining properties of the forklift.

So far, detailed embodiments of the caster wheel suspension apparatus of the reach type forklift according to the disclosure has been described. However, it is obvious that various modifications may be made without departing from the scope of the disclosure.

Therefore, the scope of the disclosure should not be limited to the above-described embodiments, but should be defined not only by the claims which will be described below but also by equivalents of the claims.

Thus, it should be understood that the embodiments described above are merely for illustrative purposes and not for limitation purposes in all aspects. The scope of the disclosure is defined by the claims which will be described below rather than by the detailed description, and all changes or modifications derived from the meaning and scope of the claims and their equivalent concepts should be interpreted as being included in the scope of the disclosure.

What is claimed is:

1. A caster wheel suspension apparatus of a reach type forklift including a driving wheel provided at one side of a lower portion of a body and a caster wheel provided at another side of the lower portion of the body, the caster wheel suspension apparatus comprising:
a fixed plate including guide rods respectively fixed to front and rear sides of a lower surface of the fixed plate, the fixed plate fixed to the body;
a movable plate including a movable pipe surrounding each of the guide rods and configured to move upward and downward along the guide rod;
a suspension spring surrounding the movable pipe and positioned between the lower surface of the fixed plate and an upper surface of the movable plate; and
a caster assembly configured to enable the caster wheel to freely rotate according to a driving action and a steering action of the driving wheel, the caster assembly coupled to a lower surface of the movable plate.

2. The caster wheel suspension apparatus of claim 1, wherein
each of the guide rods comprises
a first stopper provided at an upper end of the guide rod and configured to limit an upward movement of the movable pipe,
a second stopper provided at a lower end of the guide rod and configured to limit a downward movement of the movable pipe, and
the guide rod is fixed to the lower surface of the fixed plate by a first fastening bolt penetrating the fixed plate from an upper surface of the fixed plate.

3. The caster wheel suspension apparatus of claim 2, wherein
the fixed plate comprises a spacer provided between the lower surface of the fixed plate and an upper surface of the first stopper and configured to adjust a height of the guide rod from the fixed plate.

4. The caster wheel suspension apparatus of claim 2, wherein
the suspension spring is positioned between a lower surface of the first stopper and the upper surface of the movable plate.

5. The caster wheel suspension apparatus of claim 1, wherein
the movable plate further comprises a first nipple configured to supply lubricating oil from one side of the movable plate to a space between the movable pipe and the guide rod.

6. The caster wheel suspension apparatus of claim 1, wherein
the movable pipe comprises
a movable plate supporting portion protruding from an outer surface of a lower end of the movable pipe and supporting the movable plate, and
an inner protrusion protruding toward the guide rod from an inner surface of the movable pipe at a center in longitudinal direction of the movable pipe.

7. The caster wheel suspension apparatus of claim 6, wherein
the movable pipe further comprises
a first bushing provided between a first fixing ring provided on an inner surface of an upper end of the movable pipe and the inner protrusion, and
a second bushing provided between a second fixing ring provided on an inner surface of a lower end of the movable pipe and the inner protrusion.

8. The caster wheel suspension apparatus of claim 1, wherein
the caster assembly comprises
a caster housing including a caster bracket shaft configured to rotate according to a steering action of the driving wheel, and fixed and coupled to the movable plate, and
a caster bracket including a caster wheel shaft to which the caster wheel is coupled, the caster wheel shaft configured to rotate according to a driving action of the driving wheel, the caster bracket fixed and coupled to a lower end of the caster bracket shaft.

9. The caster wheel suspension apparatus of claim 8, wherein
the caster assembly further comprises
a caster bracket shaft bearing provided between an inner side of the caster housing and an outer surface of the caster bracket shaft, and
a caster wheel shaft bearing provided between the caster bracket and an outer surface of the caster wheel shaft.

10. The caster wheel suspension apparatus of claim 9, wherein
the caster housing comprises a second nipple configured to supply lubricating oil from an upper surface of the caster housing to the caster bracket shaft bearing.
